(19) United States
(12) Patent Application Publication
(10) Pub. No.: US 2009/0186128 A1
(43) Pub. Date: Jul. 23, 2009

(54) Beverage health formulations

(76) Inventor: Shahram A. Banayan, La Jolla, CA (US)

Correspondence Address: MICHAEL A. ERVIN, 8202 TALBOT COVE, AUSTIN, TX, 78746, US

(21) Appl. No.: 12/009,657

(22) Filed: Jan. 22, 2008

(51) Int. Cl. A23L 2/02; A23L 1/302; A23L 2/52; A23F 3/40; C12G 3/00

(52) U.S. Cl. 426/72; 426/73; 426/592; 426/599; 426/597

(57) ABSTRACT

Dietary supplement formulations are described that use structured water to provide increased hydration and therefore improved delivery of important health factors such as vitamins, minerals, and soluble fibers to beers, liquors, and various juice drinks.

### BACKGROUND OF INVENTION

The instant invention relates to vitamins, minerals, and dietary supplements; health formulations that can be added to water to create beverages that provide for high absorption of healthy ingredients that are delivered with excellent taste. One aspect of ensuring this high absorption is the use of structured waters in various combinations with unique sweeteners, soluble fibers, and juice concentrates to give outstanding flavor coupled with low glycemic index and provide healthy fiber action for the body. In addition the combination of structured waters with some alcoholic beverages has been found to provide the euphoric experience of an alcoholic drink without the dehydrating effect often associated with alcohols.

Numerous investigators have explored the beneficial aspects of modifying the characteristics of water to enhance the response of human cells to the water. Water is composed of individual water molecules that associate with others through hydrogen bonding. Liquid water has been described as a mixture of hydrogen bonded clusters and unbonded molecules. At least five species have been described: unbonded molecules, tetrahydrogen bonded molecules in the interior of a cluster; and surface molecules connected to the cluster by 1, 2 or 3 hydrogen bonds. Under normal conditions, natural clustering of water molecules is short lived and the cluster size is unpredictable. But numerous investigators have shown that water can be treated by various methodologies to have a more ordered and stable clustering of the water molecules.

Such treated water has been given several names by different investigators and is variously called “clustered”, “microclustered”, “nano-clustered”, “altered”, “oxygenated”, “functional” or simply “structured” water. This discussion will use the term structured water for clarity but it should be understood that the term structured water can also refer to many of the aforementioned names.

Methodologies for producing such structured waters have been described in several patents. A process for achieving the “B” type-basic biologically stimulative (S-water) water is described in Romanian Patent no. 88053 and a process for achieving the “A” type-acid biologically inhibitive (I-water) water, is described in Romanian Patent no. 88054, The processes consist of a cylindrical and parallelipipedic column within which two cylindrical or three lamellar electrodes are concentrically or parallel placed, made of noble materials such as platinum, separated from one another by one or two identical cylindrical or lamellar porous membranes placed so that make a central compartment for circulating the input water meant to upstream structuring and two side compartments for gathering the acid and basic structured water, respectively. Manzatu (U.S. Pat. No. 5,846,397) describes an apparatus for producing structured water using a parallelipipedic column containing a spaced electrode assembly and porous electrodes that generates and collects I and S waters in separate chambers. Lorenzen (U.S. Pat. No. 5,711,950) describes the production of “micro clustered” water by boiling water to produce steam and passing the steam across a magnetic field while exposing it to certain wavelengths of light and treating the condensed steam with metasilicate salts and either yeasts or antiviral pharmaceutical agents. Hwang (U.S. Pat. No. 6,722,253) describes a methodology for producing “hexagonal” and “pentagonal” structured waters using electroylysus of water as well as magnetization as the method of generating the structured water and a rapid freezer to store the hexagonal water. Shim (U.S. Pat. No. 5,647,974) describes the use of rotating magnets in pools of temperature-controlled water to generate hexagonal structured water.

An alternate approach generates moving water into a centrifugal vortex movement and then passes it through a low level magnetic field that infuses a series of vibrational frequencies in an infinitely modulating sequence. The result is a liquid with the water macromolecular structures reduced into smaller structures that are more readily available for absorption into living cells.

Much has been written about the health benefits of structured water. The theory underlying the work is that water in living cells is more effective in hydration if it is in a more structured state. Further claims are that structured water is effective in nutrient transfer through cellular membranes and in intra and inter-cellular communication functions. Investigators on this subject have claimed that structured water results in enhanced metabolic efficiency, maintenance of normal electrical properties of the cells and cellular systems in the body, significant amplification of the effects of nutritional supplementation, enhanced cell regeneration and rejuvenation, enhances the body's immune defense system.

Regardless of whether the benefits of structured water are primarily those of greatly improved hydration or also include many of the other claims, the interest in consuming structured water as a drink has grown significantly in recent years. This has resulted in a number of studies and patents on various methods of generating structured water. The structured water produced in these various approaches has been used primarily as a healthier drinking water as well as an additive in various skin treatments.

An aspect of the instant invention is the combination of structured water, produced by any of the above described means, in particular beverages to augment their hydration power. The inventor has found that the combination of structured waters with certain beverage combinations results in significantly improved hydration effects for consumers. In particular it has been found that combinations that include particular juice concentrates, particular sweetener combinations, and in some instances soluble fibers, provide a superior health effect for consumers by offering improved hydration coupled with healthy additives.

Another aspect of the instant invention is the use of such structured waters and their accompanying hydration effects to greatly enhance the euphoric effects of alcoholic beverages by removing one of the normal side effects of alcohol, that is it's dehydrating effect. The invention includes the use of structured water in beer and other alcohol formulations.

Most health organizations and the federal government recognize the importance of dietary fiber. The Dietary Guidelines for Americans published jointly by the United States Departments of Agriculture and Health and Human Services recommend eating foods that have adequate amounts of fiber. The National Cancer Institute recommends 20 to 30 grams of fiber per day with an upper limit of 35 grams.

Dietary fiber is plant material that is resistant to breakdown (digestion) by the human digestive system. In general, there are two major kinds of dietary fiber-insoluble (cellulose, hemicellulose, lignin) and soluble (gums, mucilages, pectins). Insoluble fiber promotes normal elimination by providing bulk for stool formation and hastening the passage of the stool through the colon. Soluble fibers also plays a healthy role in digestion and blood sugar control by slowing down the processing of sugars in digestion and thereby reducing the insulin response. Studies also indicate that soluble fibers may play a role in reducing the level of serum cholesterol in the blood. This could also be related to the insulin response as their are indications that insulin has a role in producing the production of triglycerides and unhealthy serum cholesterols in the liver.

Numerous attempts have been made to provide soluble fibers in beverages that provide the needed level of dietary soluble fiber while also delivering acceptable taste. Taste in this case is more than just an acceptable level of flavorings. Many sweetening and flavoring systems based on low sugar content have disappointed due to a flat flavor that does not appeal to the human tongue and often leave an unpleasant aftertaste. The addition of soluble fibers makes that a more challenging proposition.

Providing the sweetening effect is a challenge. Glycemic index has increasingly become recognized as a key metric in keeping blood sugar levels under better control and thus reducing or eliminating the “insulin response” that occurs when blood sugar spikes after ingestion of food or drink.

### BRIEF SUMMARY OF INVENTION

An unmet need then is for hydrating beverages with various combinations of fiber and sweetening compositions that have an appealing flavor with little aftertaste coupled with low glycemic index blended with various dietary supplements to give a beverage that provides for high absorption of healthy ingredients. This need is met by the combination of structured waters with certain combinations of juice concentrates, natural and synthetic sweeteners, and soluble fibers.

These goals can be realized by use of a soluble fiber health formulation, including at least the dietary supplement Luo Han Kuo fruit juice concentrate; combined with structured water.

A further aspect of the invention is the addition of certain soluble fibers to such a hydrating drink to further enhance the health aspects of such a beverage.

A further aspect of the invention is the addition of helpful vitamins, minerals, and other dietary supplements to such a hydrating drink that further enhance the health aspects of such a beverage.

A further aspect of the invention is the combination of structured water and various teas. This can be realized by a hydrating health formulation, including at least structured water; and a tea.

A further aspect of the invention is the combination of structured water with any beer prepared by a fermentation process. This combination can be either the addition of structured water to a prepared beer or the treatment of a prepared beer through a water structuring process.

A further aspect of the invention is the combination of structured water with any distilled alcoholic beverage. This combination can be either the addition of structured water to a distilled alcoholic beverage or the treatment of a distilled alcoholic beverage through a water structuring process.

### DESCRIPTION OF DRAWINGS

No drawings.

### DETAILED DESCRIPTION OF THE INVENTION

An earlier U.S. application by Shahram A. Banayan (U.S. application Ser. No. 11/787,346) describes a particular combination of a sweetener package with some soluble fibers and leads to an especially flavorful combination that addresses many health needs of consumers. A naturally sweet fruit available from China called Luo Han Kuo was used to create a fruit juice concentrate that when combined with some low calorie sweeteners provide an especially good sweetener package for soluble fibers in water. That application also described additional combinations of juice concentrates or extracts, vitamins, minerals, and other health supplements that in combination result in a complete health beverage. The health benefits of this type of drink though are limited by the extent to which the components pass through the cell membranes of the consumer. An important aspect of the instant invention is the significant augmentation of transfer of ingredients into cells by the hydration effects of structured water.

In all of the health drink combinations to be described the structured water used can be applied as follows. As a first step spring water, mineral water, filtered municipal water, distilled or reverse osmosis or deionizer water is processed through any of the water structuring processes described earlier, then such structured water goes into the mixing tank and added to all the ingredients. As a second step the mixed batch of the ingredients is processed through the water structuring process to further treat the molecules of the vitamins, minerals and the dietary supplements for fastest and highest absorption of the water, the vitamins, the minerals and the dietary supplements into the blood stream and the cells. The invention also anticipates that the health beverage can be made using only one of the above-described steps, either the first step or the second step.

One embodiment of the instant invention is the particular combination of the soluble fiber inulin, erythritol sweetener, and Luo Han Kuo fruit juice concentrate. When combined with other dietary supplements, natural fruit flavors, citric acid, and natural colors and structured water is added, a very useful, healthy, and flavorful beverage combination is available that provides a low glycemic index drink for health conscious consumers that is significantly enhanced by the addition of the structured water.

It has also been found that in addition to inulin the soluble fibers polydextrose and fibersol are useful for working in conjunction with Luo Han Kuo fruit juice concentrate, erythritol, and structured water.

In conjunction with Luo Han Kuo fruit juice concentrates other useful sweeteners have been found to work well. These include aspartame, saccharin, sucralose, neoetame, alitame, cyclamate, FOS, sorbitol, mannitol, xilitol, D-xylose, acesulfame, Isomalt, stevia, sucrose, brown sugar, evaporated cane juice, cane juice. Any and all fruit juices, any and all fruit juice concentrates, corn syrup, fructose, high fructose corn syrup, honey, maple syrup.

The following combinations are all aspects of the instant invention. They are proposed in two different formats. The first format is as described with Luo Han Kuo fruit juice concentrate, structured water, and a soluble fiber in combination with different packages that provide benefits such as electrolyte replacement, antioxidant characteristics, strengthening of the immune system, support of healthy skin, support of human endurance, low carbohydrates, and low calories, all with structured water added. The same combinations are then proposed with low glycemic index sweeteners without the Luo Han Kuo fruit juice concentrate and soluble fiber.

In one embodiment, in addition to the fiber, sweetener, and Luo Han Kuo fruit juice concentrate a formulation of active mineral complexes can be added to structured water and natural or artificial flavors to produce a healthful low calorie mineral enhanced beverage that provides optimal electrolyte replacement. The combination of these with a useful soluble fiber and sweetener package delivers healthy minerals to the end consumer.

In another embodiment, in addition to the fiber, sweetener, and Luo Han Kuo fruit juice concentrate a formulation comprising vitamins A, C, Niacin, B3, B5, B6, B12, calcium, magnesium, zinc, selenium, manganese, potassium, chromium, alpha lipoic acid, citrus bioflavonoid, grape seed and grape skin extracts, kudzu extract can be added to structured water and natural or artificial flavors as a high potency, low calorie immune defense beverage that strengthens the human immune system. In addition the final mixed batch can possibly then be processed through the re-structuring process to further reduce the ingredients in the batch to further improve the hydrating effect of the mixture.

In another embodiment, in addition to the fiber, sweetener, and Luo Han Kuo fruit juice concentrate a formulation comprising CoQ10, citric acid, and vitamin E can be added to structured water and natural or artificial flavors to provide a beverage that has superior antioxidant characteristics. In addition the final mixed batch can possibly then be processed through the re-structuring process to further reduce the ingredients in the batch to further improve the hydrating effect of the mixture.

In another embodiment, in addition to the fiber, sweetener, and Luo Han Kuo fruit juice concentrate a formulation comprising Vitamin C, calcium, grape seed extract, grape skin extract, citric acid, alpha lipoic acid, DMAE, acetyl-L-carnitine can be added to structured water and natural or artificial flavors to provide a beverage that supports healthy skin tissue. In addition the final mixed batch can possibly then be processed through the re-structuring process to further reduce the ingredients in the batch to further improve the hydrating effect of the mixture. In addition the final mixed batch can possibly then be processed through the re-structuring process to further reduce the ingredients in the batch to further improve the hydrating effect of the mixture.

In another embodiment, in addition to the fiber, sweetener, and Luo Han Kuo fruit juice concentrate a formulation comprising green tea, grape seed extract, grape skin extract, citrus bioflavonoid, citric acid, kudzu extract can be added to structured water and natural or artificial flavors to provide a beverage that has superior antioxidant characteristics. In addition the final mixed batch can possibly then be processed through the re-structuring process to further reduce the ingredients in the batch to further improve the hydrating effect of the mixture. In addition the final mixed batch can possibly then be processed through the re-structuring process to further reduce the ingredients in the batch to further improve the hydrating effect of the mixture.

In another embodiment, in addition to fiber, sweetener and Luo Han Kuo juice concentrate, a formulation comprising white tea, grape seed and grape skin extracts, citrus bioflavonoid, citric acid, and kudzu extract, can be added to structured water and natural or artificial flavors to provide a low calorie beverage that has superior antioxidant characteristics. In addition the final mixed batch can possibly then be processed through the re-structuring process to further reduce the ingredients in the batch to further improve the hydrating effect of the mixture.

In another embodiment, in addition to the fiber, sweetener, and Luo Han Kuo fruit juice concentrate a formulation comprising black tea, grape seed extract, grape skin extract, citrus bioflavonoid, citric acid, and kudzu extract can be added to structured water and natural or artificial flavors to provide a low calorie beverage that has superior antioxidant characteristics. In addition the final mixed batch can possibly then be processed through the re-structuring process to further reduce the ingredients in the batch to further improve the hydrating effect of the mixture.

In another embodiment, in addition to the fiber, sweetener, and Lo Han Kuo fruit juice concentrate and or extract a formulation comprised of organic Kombucha cultured tea can be added to structured water and natural or artificial flavors to provide a beverage that provides active enzymes, viable probiotics, amino acids, antioxidants and polyphenols. In addition the final mixed batch can possibly then be processed through the re-structuring process to further reduce the ingredients in the batch to further improve the hydrating effect of the mixture.

In another embodiment, in addition to the fiber, sweetener, and Luo Han Kuo fruit juice concentrate a formulation comprising vitamins C, B3, B5, B6, B12, zinc, chromium, taurine, citric acid, and ribose can be added to structured water and natural or artificial flavors to provide a low calorie beverage that supports human endurance. In addition the final mixed batch can possibly then be processed through the re-structuring process to further reduce the ingredients in the batch to further improve the hydrating effect of the mixture.

In another embodiment, in addition to the fiber, sweetener, and Lo Han Kuo fruit Juice Concentrate and or extract a formulation comprising Vitamins C, B3, B5, B6, B12, magnesium and Potassium as well as L-Theanine (Suntheanine) can be added to structured water and natural or artificial flavors as a low calorie beverage that provides relaxation without drowsiness. In addition the final mixed batch can possibly then be processed through the re-structuring process to further reduce the ingredients in the batch to further improve the hydrating effect of the mixture.

In another embodiment, in addition to the fiber, sweetener, and Lo Han Kuo fruit Juice Concentrate and or extract a formulation comprising Vitamin C Niacin, B3, B5, B6, B12, magnesium, potassium as well as the extracts of the Acai, Blue berries and Pomegranate can be added to structured water and natural or artificial flavors as a high potency, low calorie beverage that provides a combination of antioxidants.

In another embodiment, in addition to the fiber, sweetener, and Luo Han Kuo fruit juice concentrate a formulation comprising pomegranate juice or extract, blueberry juice or extract and acai juice or extract, citrus bioflavonoid, grape seed and grape skin extracts, citric acid, and kudzu extract can be added to structured water and natural or artificial flavors to provide a low calorie beverage that has superior antioxidant characteristics. In addition the final mixed batch can possibly then be processed through the re-structuring process to further reduce the size of the nutrient particles and molecules of the ingredients in the batch to further improve the hydrating effect of the mixture.

In another embodiment, in addition to fiber, sweetener and Luo Han Kuo fruit juice concentrate, a formulation comprising protein, vitamins A, C, B3, B5, B6, B12, niacin, calcium, magnesium, manganese, zinc, selenium, citric acid, and potassium can be added to structured water and natural or artificial flavors to provide a low calorie beverage for weight loss support. In addition the final mixed batch can possibly then be processed through the re-structuring process to further reduce the size of the nutrient particles and molecules of the ingredients in the batch to further improve the hydrating effect of the mixture.

In another embodiment, in addition to fiber, sweetener and Luo Han Kuo fruit juice concentrate, a formulation comprising carbohydrates can be added to structured water and natural or artificial flavors to provide a low calorie carbohydrate beverage. In addition the final mixed batch can possibly then be processed through the re-structuring process to further reduce the size of the nutrient particles and molecules of the ingredients in the batch to further improve the hydrating effect of the mixture.

In another embodiment, in addition to the fiber, sweetener, and Luo Han Kuo fruit juice concentrate a formulation comprising Vitamins B3, B5, B6, B12, caffeine, guarana, L-carnitine, citric acid, and ginseng can be added to structured water and natural or artificial flavors to provide a low calorie beverage that provides energy. In addition the final mixed batch can possibly then be processed through the re-structuring process to further reduce the size of the nutrient particles and molecules of the ingredients in the batch to further improve the hydrating effect of the mixture.

In another embodiment, in addition to the fiber, sweetener, and Lo Han Kuo fruit Juice Concentrate and or extract a formulation comprising Vitamins A, B3, B5, B6, B12 as well as Luetin can be added to structured water and natural or artificial flavors as a high potency, low calorie beverage that supports healthy eye sight. In addition the final mixed batch can possibly then be processed through the re-structuring process to further reduce the size of the nutrient particles and molecules of the ingredients in the batch to further improve the hydrating effect of the mixture.

In another embodiment, in addition to a low glycemic index sweetener, a formulation of active mineral complexes and citric acid can be added to structured water and natural or artificial flavors to produce a healthful low calorie mineral enhanced beverage that provides optimal electrolyte replacement. The combination of these with a useful soluble fiber and sweetener package delivers healthy minerals to the end consumer. In addition the final mixed batch can possibly then be processed through the re-structuring process to further reduce the size of the nutrient particles and molecules of the ingredients in the batch to further improve the hydrating effect of the mixture.

In another embodiment, in addition to a low glycemic index sweetener, a formulation comprising vitamins A, C, Niacin, B3, B5, B6, B12, calcium, magnesium, zinc, selenium, manganese, potassium, chromium, alpha lipoic acid, citrus bioflavonoid, grape seed and grape skin extracts, citric acid, and kudzu extract can be added to structured water and natural or artificial flavors as a high potency, low calorie immune defense beverage that strengthens the human immune system. In addition the final mixed batch can possibly then be processed through the re-structuring process to further reduce the size of the nutrient particles and molecules of the ingredients in the batch to further improve the hydrating effect of the mixture.

In another embodiment, in addition to a low glycemic index sweetener, a formulation comprising CoQ10, citric acid, and vitamin E can be added to structured water and natural or artificial flavors to provide a beverage that has superior antioxidant characteristics. In addition the final mixed batch can possibly then be processed through the re-structuring process to further reduce the size of the nutrient particles and molecules of the ingredients in the batch to further improve the hydrating effect of the mixture.

In another embodiment, in addition to a low glycemic index sweetener, a formulation comprising vitamin C, calcium, grape seed extract, grape skin extract, alpha lipoic acid, DMAE, acetyl-L-carnitine and citric acid can be added to structured water and natural or artificial flavors to provide a beverage that supports healthy skin tissue. In addition the final mixed batch can possibly then be processed through the re-structuring process to further reduce the size of the nutrient particles and molecules of the ingredients in the batch to further improve the hydrating effect of the mixture.

In another embodiment, in addition to a low glycemic index sweetener, a formulation comprising green tea, grape seed extract, grape skin extract, citrus bioflavonoid, kudzu extract can be added to structured water and natural or artificial flavors to provide a beverage that has superior antioxidant characteristics. In addition the final mixed batch can possibly then be processed through the re-structuring process to further reduce the size of the nutrient particles and molecules of the ingredients in the batch to further improve the hydrating effect of the mixture.

In another embodiment, in addition to a low glycemic index sweetener, a formulation comprising of white tea, grape seed and grape skin extracts, citrus bioflavonoid, citric acid, and kudzu extract, can be added to structured water and natural or artificial flavors to provide a low calorie beverage that has superior antioxidant characteristics. In addition the final mixed batch can possibly then be processed through the re-structuring process to further reduce the size of the nutrient particles and molecules of the ingredients in the batch to further improve the hydrating effect of the mixture.

In another embodiment, in addition to a low glycemic index sweetener, a formulation comprising black tea, grape seed extract, grape skin extract, citrus bioflavonoid, citric acid, and kudzu extract can be added to structured water to provide a low calorie beverage that has superior antioxidant characteristics. In addition the final mixed batch can possibly then be processed through the re-structuring process to further reduce the size of the nutrient particles and molecules of the ingredients in the batch to further improve the hydrating effect of the mixture.

In another embodiment, in addition to a low glycemic index sweetener, a formulation comprising vitamins C, B3, B5, B6, B12, zinc, chromium, taurine, and ribose can be added to structured water and natural or artificial flavors to provide a low calorie beverage that supports human endurance. In addition the final mixed batch can possibly then be processed through the re-structuring process to further reduce the size of the nutrient particles and molecules of the ingredients in the batch to further improve the hydrating effect of the mixture.

In another embodiment, in addition to a low glycemic index sweetener, a formulation comprising pomegranate juice or extract, blueberry juice or extract and acai juice or extract, citrus bioflavonoid, grape seed and grape skin extracts and kudzu extract can be added to structured water and natural or artificial flavors to provide a low calorie beverage that has superior antioxidant characteristics. In addition the final mixed batch can possibly then be processed through the re-structuring process to further reduce the size of the nutrient particles and molecules of the ingredients in the batch to further improve the hydrating effect of the mixture.

In another embodiment, in addition to a low glycemic index sweetener, a formulation comprising protein, vitamins A, C, B3, B5, B6, B12, niacin, calcium, magnesium, manganese, zinc, selenium, and potassium can be added to structured water and natural or artificial flavors to provide a low calorie beverage for weight loss support. In addition the final mixed batch can possibly then be processed through the re-structuring process to further reduce the size of the nutrient particles and molecules of the ingredients in the batch to further improve the hydrating effect of the mixture.

In another embodiment, in addition to a low glycemic index sweetener, a formulation comprising carbohydrates can be added to structured water and natural or artificial flavors to provide a low calorie carbohydrate beverage. In addition the final mixed batch can possibly then be processed through the re-structuring process to further reduce the size of the nutrient particles and molecules of the ingredients in the batch to further improve the hydrating effect of the mixture.

In another embodiment, in addition to a low glycemic index sweetener, a formulation comprising vitamins B3, B5, B6, B12, caffeine, guarana, L-carnitine and ginseng can be added to structured water and natural or artificial flavors to provide a low calorie beverage that provides energy. In addition the final mixed batch can possibly then be processed through the re-structuring process to further reduce the size of the nutrient particles and molecules of the ingredients in the batch to further improve the hydrating effect of the mixture.

In another embodiment, organic Kombucha cultured tea can be added to structured water, and fruit juices with or without natural or artificial flavors, to provide a beverage that provides active enzymes, viable probiotics, amino acids, antioxidants and polyphenols.

The formulations mentioned above can all be converted into drinkable beverages by adding them to water. Each of these formulations can also be prepared and offered to consumers as a powdered material ready to be added to structured water by the consumer and all of those combinations are also aspects of the instant invention. In addition the final mixed batch can possibly then be processed through the re-structuring process to further reduce the ingredients in the batch to further improve the hydrating effect of the mixture.

The world's oldest and most popular alcoholic beverage is beer. Beer is produced by the fermentation of sugars derived from starch-based materials—the most common being malted barley. The starch source is steeped in water, along with certain enzymes to produce sugary wort that is then flavored with herbs, fruits, or more commonly hops. Yeast is then added to cause fermentation, which generates alcohol and side products. Beer (and other alcoholic drinks) are known to cause dehydration. It has been found that this can be substantially reversed by addition of structured water. In the case of beer the structured water can be used in the original treatment of the starch to produce the wort or structured water can be added after the fermentation process or for maximum effect structured water can be used in both steps. The invention anticipates either or both cases.

Distilled beverages are consumable liquids containing ethanol purified by distillation from a fermented substance such as fruit vegetables, or grain. Similar to the earlier discussion of beers, consumption of distilled beverages gives a dehydrating effect that diminishes the enjoyment of the drink. It has been found that the use of structured water in the manufacturing process results in a drink that is significantly less dehydrating. This is another aspect of the instant invention. In one embodiment the distillation is made with structured water. In a second embodiment the distilled beverage from the distillation can possibly then be processed through the re-structuring process to further reduce the size of the nutrient particles and molecules of the ingredients in the batch to further improve the hydrating effect of the mixture. The invention anticipates either or both cases.

While the invention has been described above with references to specific embodiments, it is apparent that many changes, modifications and variations in the materials can be made without departing from the inventive concept disclosed herein. Accordingly, the spirit and broad scope of the appended claims is intended to embrace all such changes, modifications and variations that may occur to one of skill in the art upon a reading of the disclosure.

1. A hydrating health formulation, comprising:
a. Luo Han Kuo fruit juice concentrate; and
b. structured water

2. The hydrating health formulation of claim 1 further comprising a sweetener.

3. The hydrating health formulation of claim 2 wherein said sweetener has a low glycemic index and is selected from the group consisting of: aspartame, saccharin, sucralose, neoetame, alitame, cyclamate, FOS, erythritol, sorbitol, mannitol, xilitol, D-xylose, acesulfame, isomalt, and stevia.

4. The hydrating health formulation of claim 2 wherein said sweetener is selected from the group consisting of: sucrose, brown sugar, evaporated cane juice, cane juice, fruit juices, fruit extracts, corn syrup, fructose, high fructose corn syrup, honey, and maple syrup.

5. The hydrating health formulation of claim 1 further comprising a soluble fiber material.

6. The hydrating health formulation of claim 5 wherein said soluble fiber material is selected from the group consisting of: fibersol, inulin, and polydextrose.

7. The hydrating health formulation of claim 5 wherein said soluble fiber material is inulin and said sweetener is erythritol.

8. The hydrating health formulation of claim 1 further comprising an added component selected from the group consisting of vitamin A, vitamin B3, vitamin B5, vitamin B6, vitamin B12, vitamin C, vitamin D, and vitamin E.

9. The hydrating health formulation of claim 1 further comprising an added component selected from the group consisting of L-theanine, luetin, CoQ10, DMAE, actyl-L carnitine, kudzu extract, ribose, guarana, taurine, caffeine, ginseng, and alpha lipoic acid.

10. The hydrating health formulation of claim 1 further comprising an added component selected from the group consisting of calcium, magnesium, manganese, zinc, chromium, selenium, and potassium.

11. The hydrating health formulation of claim 1 further comprising an added component selected from the group consisting of green tea, white tea, black tea, Kombucha tea, Yerba Mate tea, grape seed extract, grape skin extract, citric acid, and citrus bioflavonoids.

12. The hydrating health formulation of claim 1 further comprising an added component selected from the group consisting of pomegranate juice, pomegranate extract, blueberry juice, blueberry extract, acai juice and acai extract.

13. The hydrating health formulation of claim 1 further comprising an added component selected from the group consisting carbohydrates and proteins.

14. A hydrating health formulation, comprising:
a. structured water; and
b. a tea.

15. The hydrating health formulation of claim 14 wherein said tea is selected from the group consisting of green tea, white tea, black tea, Kombucha tea, and Yerba Mate tea.

16. A hydrating beer produced by the addition of structured water to any beer prepared by a fermentation process.

17. A hydrating beer produced by treating a beer produced by a fermentation process with a water structuring process.

18. A hydrating distilled beverage produced by the addition of structured water to a distilled beverage.

19. A hydrating distilled beverage produced by treating a distilled beverage with a water structuring process.
